(19) United States
(12) Patent Application Publication
(10) Pub. No.: US 2017/0293742 A1
(43) Pub. Date: Oct. 12, 2017

(54) INTERACTIVE MOBILE TECHNOLOGY FOR GUIDANCE AND MONITORING OF PHYSICAL THERAPY EXERCISES

(71) Applicants: Javad Sadeghi, Calgary (CA); Elaheh Rajab Zadeh Moghaddam, Calgary (CA)

(72) Inventors: Javad Sadeghi, Calgary (CA); Elaheh Rajab Zadeh Moghaddam, Calgary (CA)

(21) Appl. No.: 15/481,346

(22) Filed: Apr. 6, 2017

(30) Foreign Application Priority Data
Apr. 7, 2016 (CA) 2926440

(51) Int. Cl. G06F 19/00

(52) U.S. Cl. CPC G06F 19/3481; G06F 19/3437; G06F 19/363

(57) ABSTRACT

A physiotherapist consultant performs a core set of exercises in the Human Performance Lab while around 70 reflective markers are attached to his body joints. A set of eight Motion Analysis cameras concurrently capture a regular sampling of his joint parameters over time. After recording the raw data for each exercise, the system extracts the skeletal structure of the character from it. These skeletal animations are later applied to a 3D human model to represent different visualizations. Therefore, some post processing needs to be done on the skeletal avatar to visualize a skinned human, its muscle structure and its nerve system. In addition, the geometric notion of the data allows adding graphical overlays to the visualization such as showing the angles between joints or highlighting the affected muscles.

### CROSS-REFERENCE TO RELATED APPLICATIONS

This application claims the benefit of priority of Canadian Patent Application No. 2,926,440 filed Apr. 7, 2016, which is incorporated herein by reference.

### BACKGROUND OF THE INVENTION

### (1) Field of the Invention

The invention pertains generally to mobile computing devices as well as desktop and laptop machines equipped with depth cameras. More specifically, the invention relates to an interactive mobile technology for guidance and monitoring of physical therapy exercises and a system and method of generating personalized physical therapy exercises by machine intelligence utilizing collected patient assessment data.

### (2) Description of the Related Art

Patient non-adherence with the recommendations of healthcare providers is a well-known problem. Studies have suggested that non-adherence with physiotherapy treatment and exercise performance could be as high as 70%. If non-adherence to physiotherapy exercises is considered a human behavior then, guidelines in the patient safety and human factors literature suggest that the use of technology to mitigate this existing pattern of behavior is a more effective intervention.

Rehabilitation is usually a long and tedious process as patients are forced to constantly repeat the same exercises. A physiotherapist's role is to teach, guide and correct the patient's activities. This process usually spans across different sessions, including exercises to be done by the patients at home. Given that physiotherapy normally requires a once-a-week visit accompanied by home stretches/exercises during the day, performing the exercises correctly is the largest part of the recovery process.

In the current system, majority of the time of the clinicians is spent on manual assessment of the patients' progress. Also, the objective measures that are assessed are not accurately recorded or tracked through time. In addition, the current exercise recommendation method is based on manual handouts outlining the exercises (see FIG. 1) and the drawings can be confusing for more complex stretches. Even though physiotherapists demonstrate the exercises, quite often the lag in time from demo to first at home session can be longer than the patient's memory. This traditional process could be improved by digitally assessing the progress of the patients across different sessions and monitoring their compliance remotely.

Current screening tools that digitally record objective measures of the patients are not intelligent enough to use these measures to improve treatment plan and prescribe accurate exercise recommendations. Also, the current exercise prescription tools that are used in clinics are not accurate and engaging enough to be followed correctly by the patients. In addition, the tools that use exergames to encourage and motivate patients are not able to provide active visual feedback across multiple platforms. On the other hand, current mobile tools that are used for instruction and tracking of physiotherapy exercises at home, are either based on still images, which are not accurate enough, or based on video exercises, which do not provide 3D visual clues.

### BRIEF SUMMARY OF THE INVENTION

It is an object of some embodiments of the present invention to provide visual analytics across all platforms and employing machine learning to standardize prescription of exercise recipes.

According to an exemplary embodiment of the invention, Physio4D™ introduces a fast and efficient triage, starting from a digital onboarding process that automatizes the upfront assessment of the patients. Physio4D™ uses the time that is now wasted in the waiting room by giving the patient an iPad app to fill their onboarding information. This on-boarding process is designed by clinicians for patients using the best practice guidelines. It collects the personal information, medical history, conditions they are experiencing, and concludes with a Health Report Questionnaire. The app automatically generates a detailed PDF for clinicians to print or store in their digital records to save the documentation tracking time.

According to another exemplary embodiment of the invention, Physio4D™ enables assessment of the joint mobility of the patients by showing associated tests for each joint. By coupling a depth camera to our machine vision algorithm, we automatically detect the skeletal data and track major joints. This provides an objective, hands-off measurement of joint mobility that can be recorded into the patient profile. The objective nature of these measures make it reliable to assess patient progression. Because the system automatically detects and tracks the joints, mobility can be measured passively; Thus, clinician does not have to manually measure the patient and can use that time to take notes, direct movements, or perform other tasks. This expedites the assessment process, and allows the clinician to see more patients per day.

According to another exemplary embodiment of the invention, Physio4D™ also aims to use the off the shelf depth cameras as well as cameras of the readily available cellphone and tablet devices to track and guide the patients in front of the camera and make sure they do the exercises correctly. Using a computer vision algorithm, the skeletal information of the patients are extracted and compared with the correct skeletal movement stored in the database to provide appropriate suggestive feedback. Physio4D™'s approach is to use 3D animated exercises recorded in a motion capture (mocap) studio to allow zooming, rotating and viewing the exercises from multiple angles. This makes it possible to visualize a 3D avatar with different options e.g. skin, muscle and skeleton for better patient instruction. In addition, the analytical data logged from the patients during their gym and home exercises will be provided to the physiotherapists in different visual formats to fill the current gap between follow-up sessions and help physiotherapists provide better patient care.

Another exemplary embodiment of the invention, indicates that Physio4D™ employs machine learning to standardize the prescription of the custom exercise recipes. Physio4D™ logs the sessions from every patient to have enough training samples across all injury categories. After the software reaches to an optimum point, it assists in the decision making of the clinicians by providing predictive analytics based on all of these categories. This improves quality of the treatment and results in provision of better patient care.

These and other advantages and embodiments of the present invention will no doubt become apparent to those of ordinary skill in the art after reading the following detailed description of the preferred embodiment that is illustrated in the various figures and drawings.

### BRIEF DESCRIPTION OF THE DRAWINGS

The invention will be described in greater detail with reference to the accompanying drawings which represent preferred embodiments thereof:

FIG. 1 shows sample shoulder exercises used in clinics. Image courtesy of VHI.

FIG. 2 shows in motion capture, markers and special cameras are used to record a real movement. Image taken from Wikimedia Commons.

FIG. 3 shows physiotherapists' log-in screen in Physio4D™'s desktop application according to an exemplary embodiment.

FIG. 4 shows physiotherapists' profile screen in Physio4D™'s desktop application according to an exemplary embodiment.

FIG. 5 shows the interface for capturing frontal and lateral posture landmarks according to an exemplary embodiment.

FIG. 6 shows the frontal view posture landmarks according to an exemplary embodiment.

FIG. 7 shows the lateral view posture landmarks according to an exemplary embodiment.

FIG. 8 shows different body joints in Physio4D™'s desktop application according to an exemplary embodiment.

FIG. 9 shows associated Range of Motion (ROM) assessments for the selected body joint according to an exemplary embodiment.

FIG. 10 shows the interface for tracking ROM of the patients and recording their pain points and pain level as well as the subjective comments of the physiotherapists according to an exemplary embodiment.

FIG. 11 shows the skeletal data of the patient automatically extracted from his start position in the corresponding range of motion assessment according to an exemplary embodiment.

FIG. 12 shows the skeletal data of the patient automatically extracted from his end position in the corresponding range of motion assessment according to an exemplary embodiment.

FIG. 13 shows the interface to show the live recordings of the angles between major joints of a person according to an exemplary embodiment.

FIG. 14 shows the live recordings of the angles between major joints of a person and arc visualizations of these angles according to an exemplary embodiment.

FIG. 15 shows the progress charts for ROM and pain level in Physio4D™'s desktop application. It shows an image for the first visit of the patients before treatment and their latest image. The video section allows playing, pausing and scrolling through a skeletal recording of the patient according to an exemplary embodiment.

FIGS. 16 and 17 show Physio4D™'s Web App allows physiotherapists prescribe right exercises to their patients according to exemplary embodiments.

FIG. 18 shows Physio4D™'s Web App allows physiotherapists preview the exercises in 3D according to an exemplary embodiment.

FIG. 19 shows Physio4D™'s Web App allows physiotherapists get an overall view of patient progress according to an exemplary embodiment.

FIG. 20 shows Physio4D™'s Web App allows physiotherapists view the personal information of their patients according to an exemplary embodiment.

FIG. 21 shows Physio4D™'s Web App allows physiotherapists assign exercises to the schedule of their patients according to an exemplary embodiment.

FIGS. 22 and 23 show Physio4D™'s Web App allows physiotherapists track the progress of their patients according to exemplary embodiments.

FIG. 24 shows a sample shoulder exercise in Physio4D™'s Mobile App according to an exemplary embodiment.

FIG. 25 shows a sample analytics in Physio4D™'s Mobile App according to an exemplary embodiment.

FIG. 26 shows a block diagram of Physio4D™'s infrastructure according to an exemplary embodiment.

FIG. 27 shows patient login to the mobile application according to an exemplary embodiment.

FIG. 28 shows assigned exercises for a particular patient after the particular patient has logged in to the mobile application according to an exemplary embodiment.

FIGS. 29 and 30 show examples of actions the patient can take to the 3D animation of the assigned exercise while the 3D animations are played in order to fully understand the required motions according to an exemplary embodiment.

FIGS. 31, 32 and 33 show examples of feedback that is provided when the mobile application uses computer vision to scan the user performing the exercise and measures differences between the desired and actual movements according to an exemplary embodiment.

FIGS. 34 and 35 show reports displayed to the user on progress with the exercises according to an exemplary embodiment.

FIG. 36 shows how the system can display real-time corrective feedback on any coupled display device such as flat panel television according to an exemplary embodiment.

FIG. 37 shows how the system can transfer patient data between physiotherapist and patient devices according to an exemplary embodiment.

FIG. 38 shows both patient's accumulated time and error, but highlights accumulated Error according to an exemplary embodiment.

FIG. 39 shows the exercises with texture, wireframe or skeleton according to an exemplary embodiment.

FIG. 40 shows how a physiotherapist can schedule the frequency of doing the exercises by patients using a web-based calendar according to an exemplary embodiment.

### DETAILED DESCRIPTION

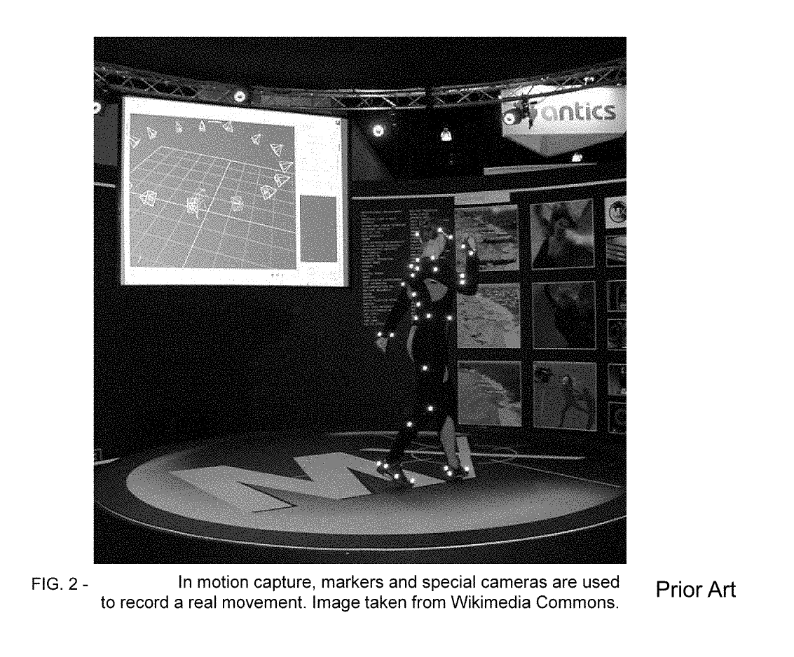

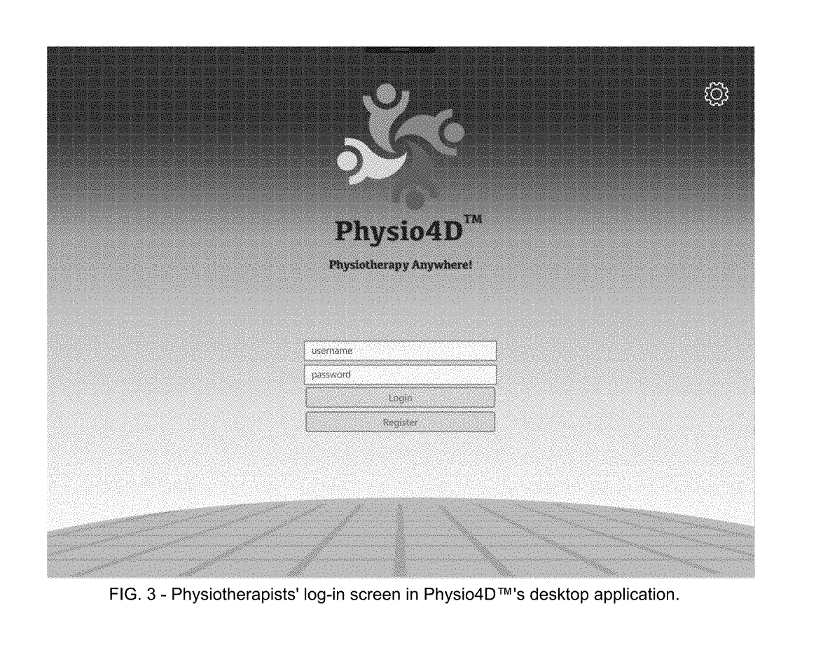

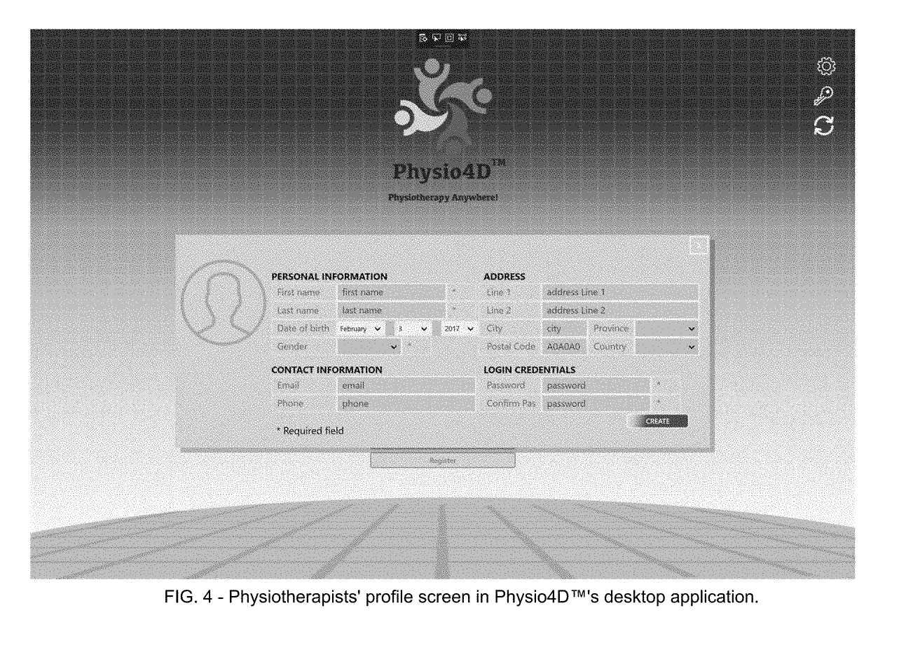

Motion capture technique (see FIG. 2), which has mainly used in the entertainment industry, has proven to be advantageous in the area of physical therapy because it has shown a higher accuracy in the diagnosis of musculoskeletal disorders. Tracking patients'activities using motion capture helps to diagnose limitations in the human body with more accuracy. However, motion capture is currently not affordable nor sufficiently mobile to be used by patients at home.

Physio4D™ benefits from the increased accuracy of the mocap and makes it affordable to the situations that a motion capture setup is not available e.g. home. First, our physiotherapist consultant performs the core set of exercises in the Human Performance Lab while around 70 reflective markers are attached to his body joints. A set of eight Motion Analysis cameras concurrently capture a regular sampling of his joint parameters over time. Although doing the capture is easy, determining how to process the data (to store in a database) is challenging.

After recording the raw data for each exercise, we will extract the skeletal structure of the character from it. These skeletal animations are later applied to a 3D human model to represent different visualizations. Therefore, some post processing needs to be done on the skeletal avatar to visualize a skinned human, its muscle structure and its nerve system. In addition, the geometric notion of the data allows adding graphical overlays to the visualization such as showing the angles between joints or highlighting the affected muscles.

2-1) Physiotherapist Version

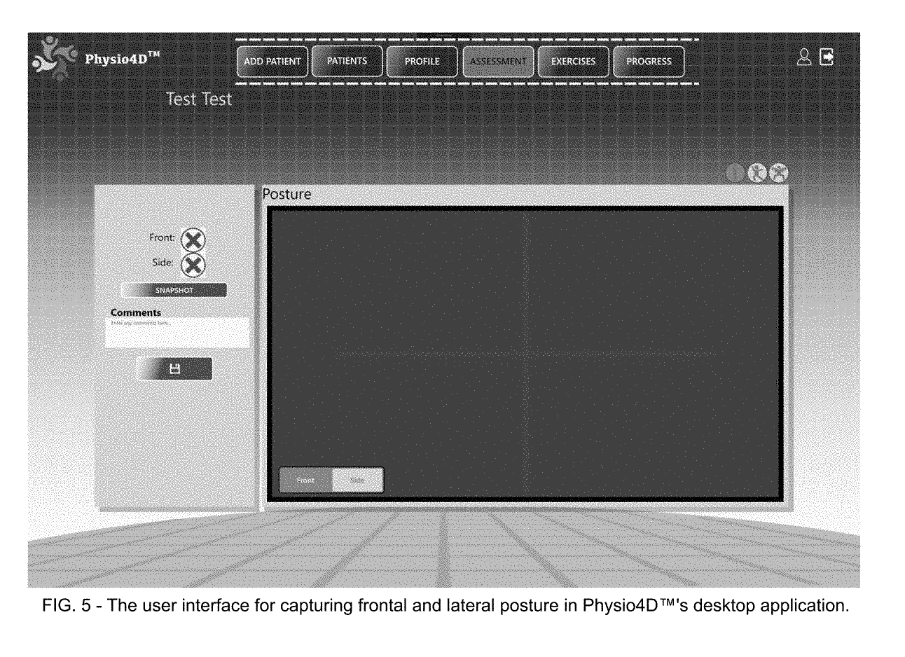

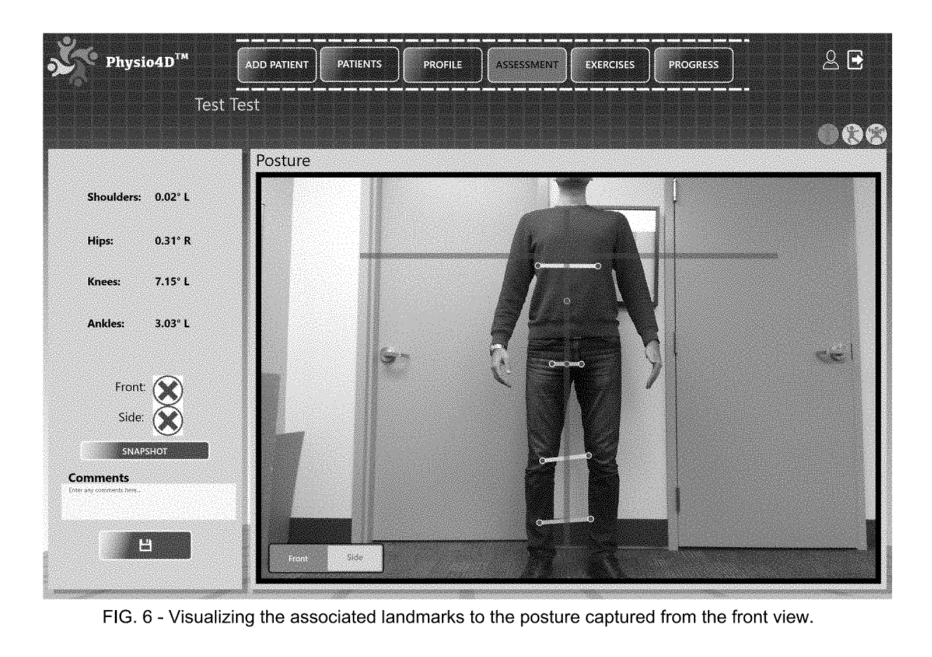

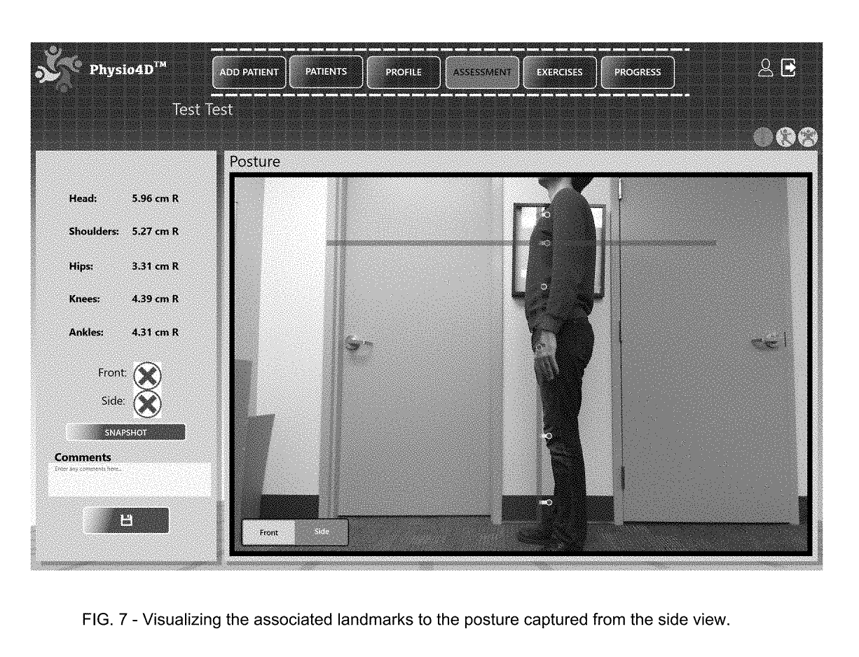

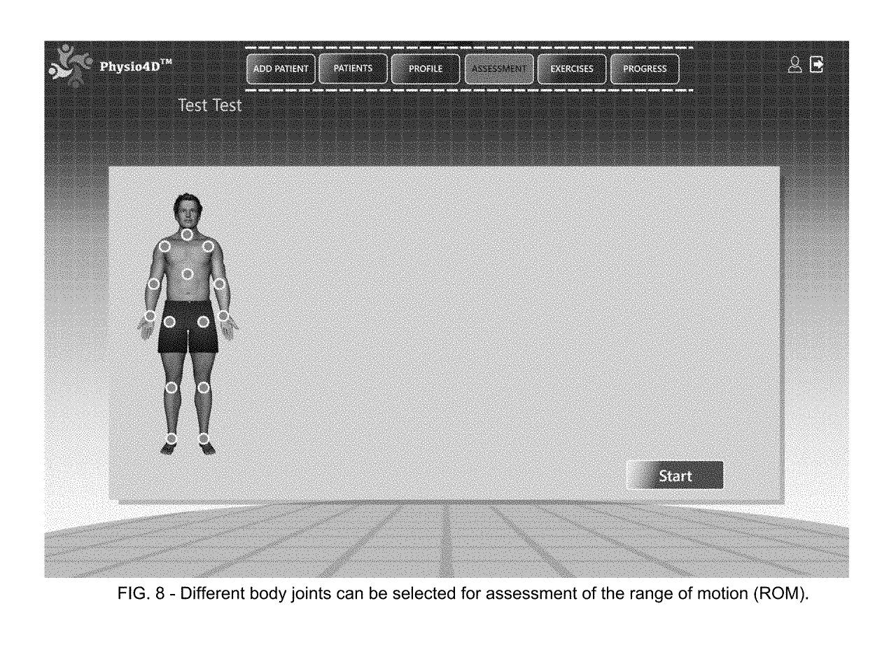

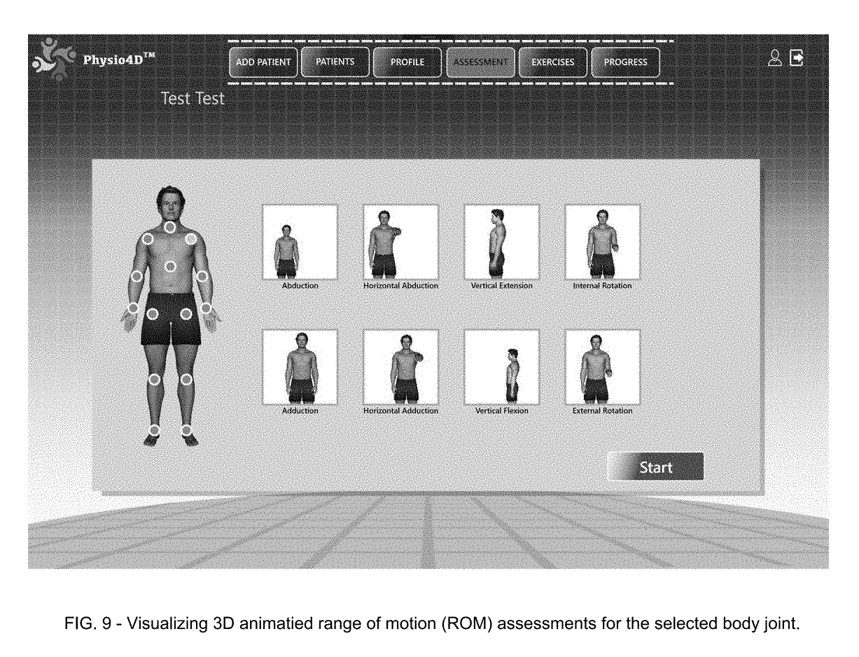

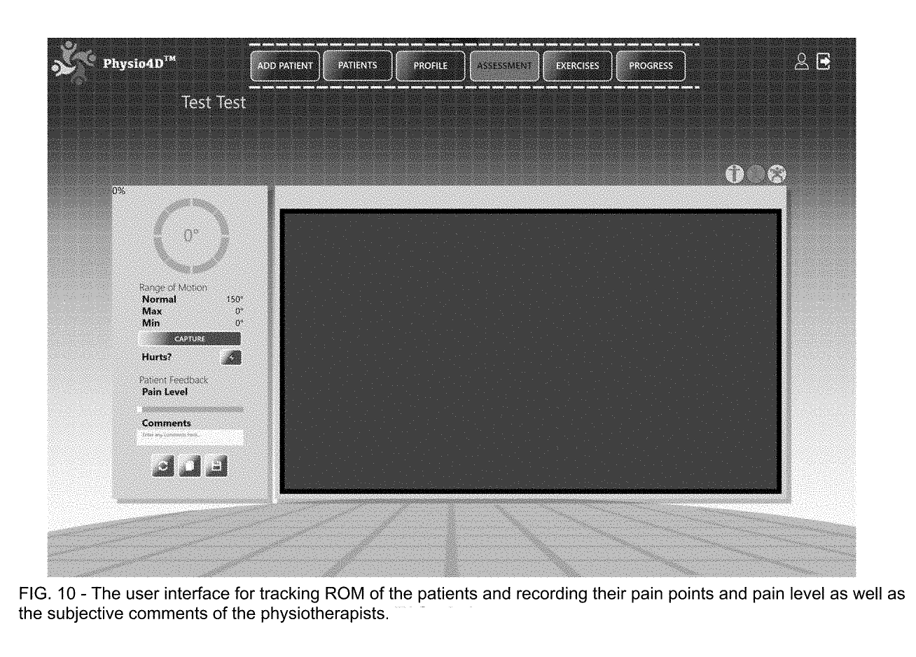

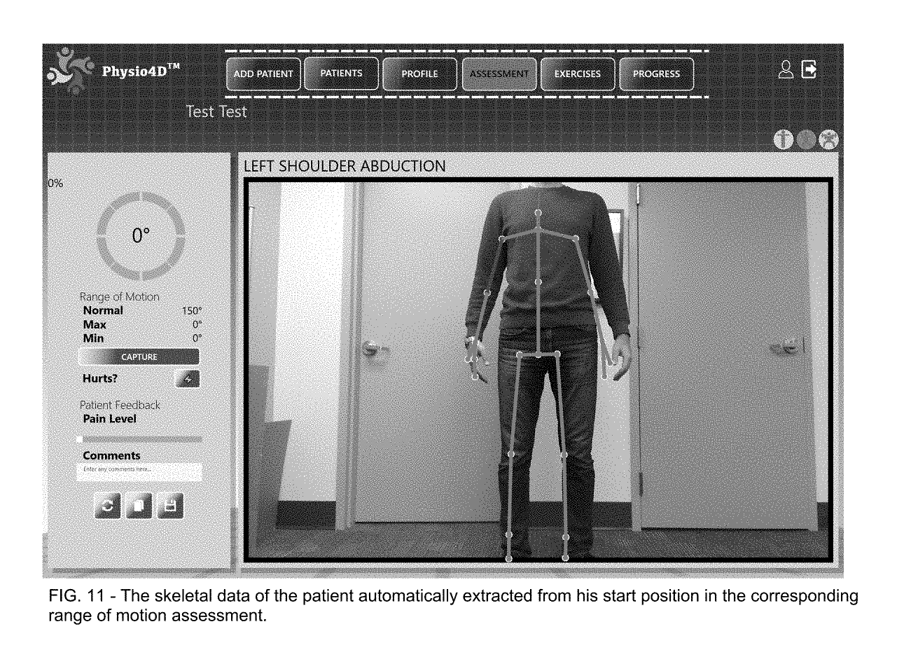

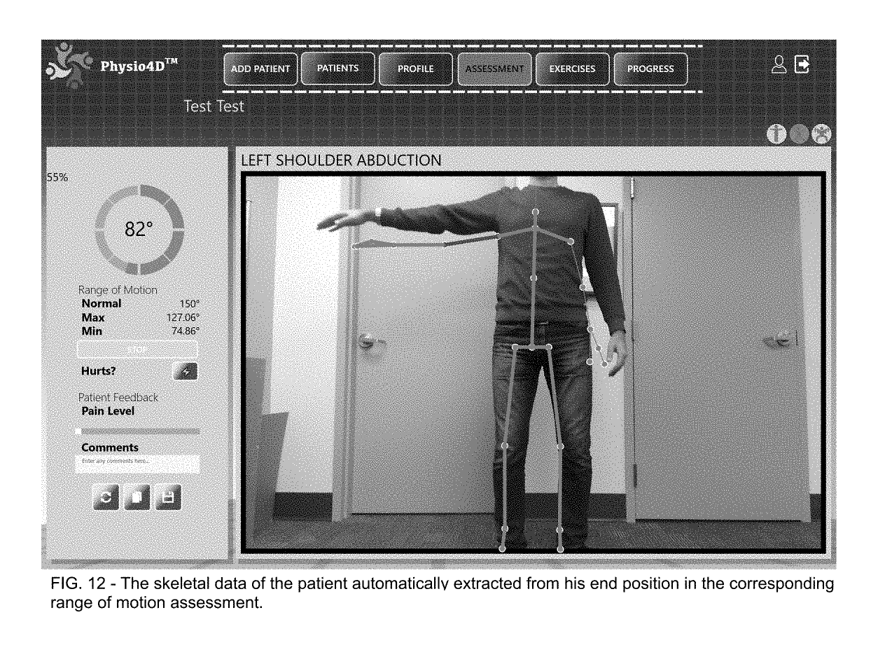

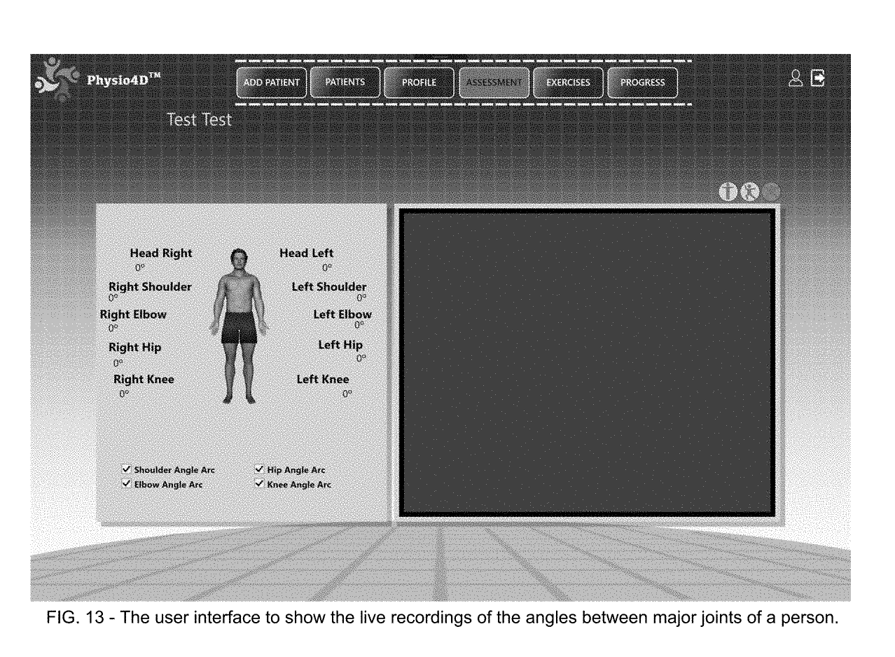

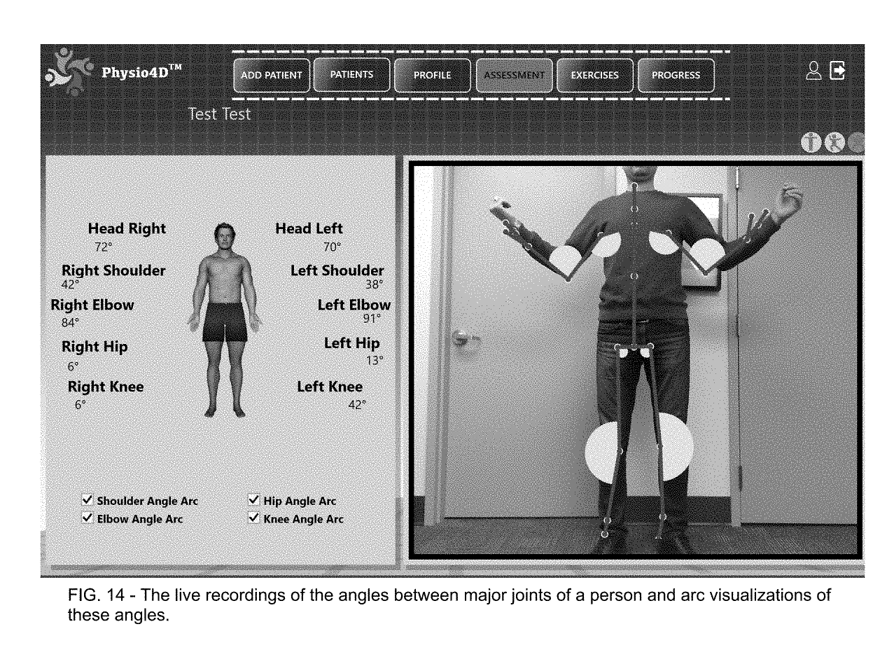

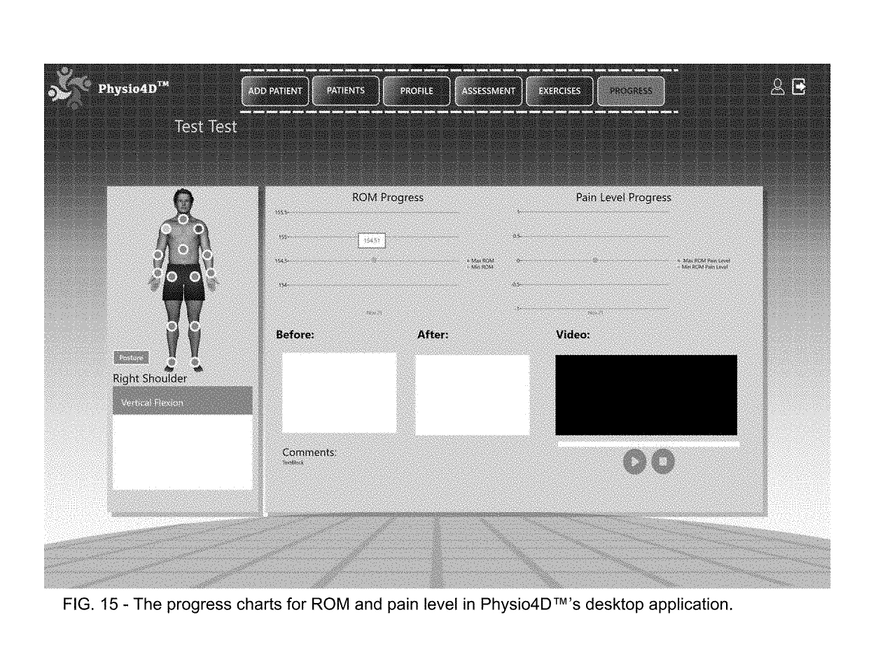

This version is targeted to the physiotherapists and allows them to select a joint (see FIG. 8) and choose an standard assessment for that joint (see FIG. 9). By coupling a depth camera to our machine vision algorithm, we can automatically detect the skeletal data and track the joint's Range of Motion (see FIG. 10). The objective nature of machine vision means that each measurement is the same. This reduces variability between visits and provides a more reliable measure of patient progression. Physiotherapists can also use this system to assess the posture of the patients (see FIG. 5) from the frontal and lateral views. It can also shows the live movements of the angles between major joints (see FIG. 13) to help assessment of the functionality of their movements. This version also allows physiotherapists to examine the range of motion of their patients in their follow-up visits by re-playing the skeletal motions captured from the exercises.

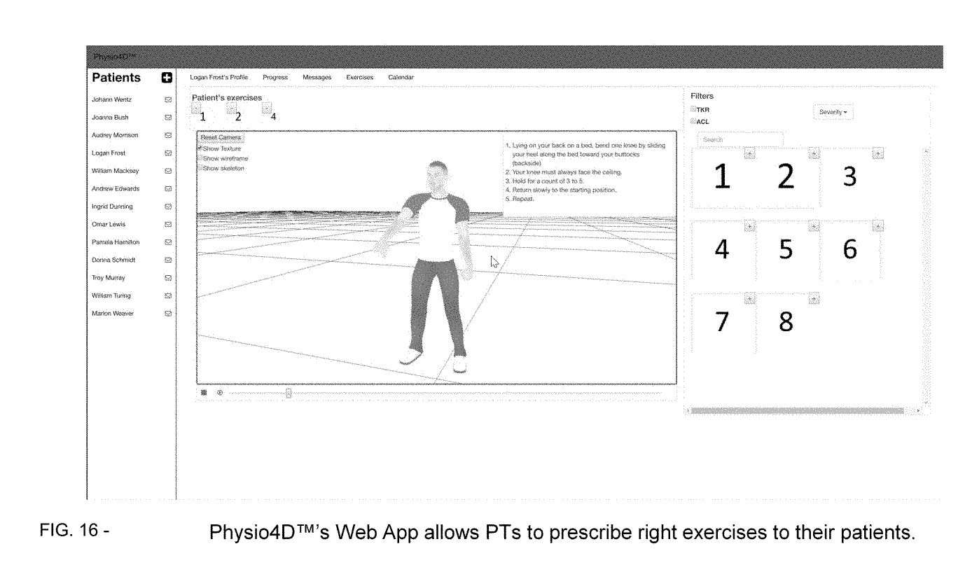

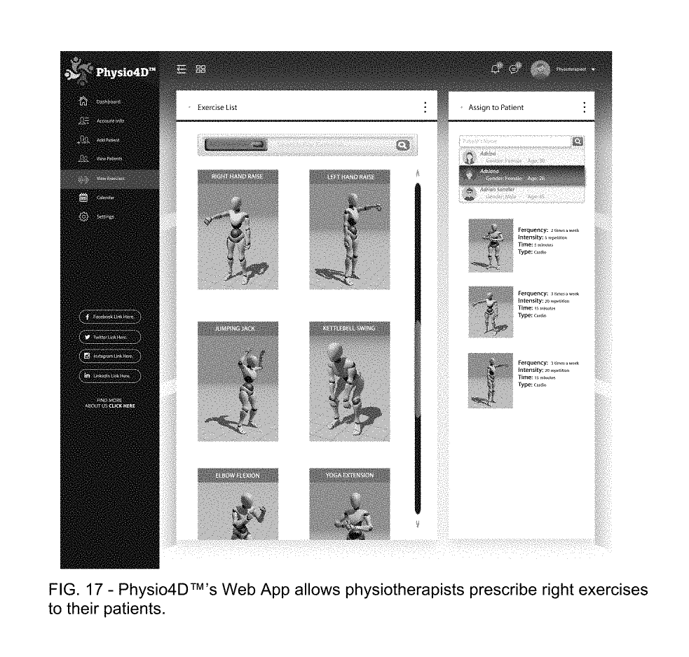

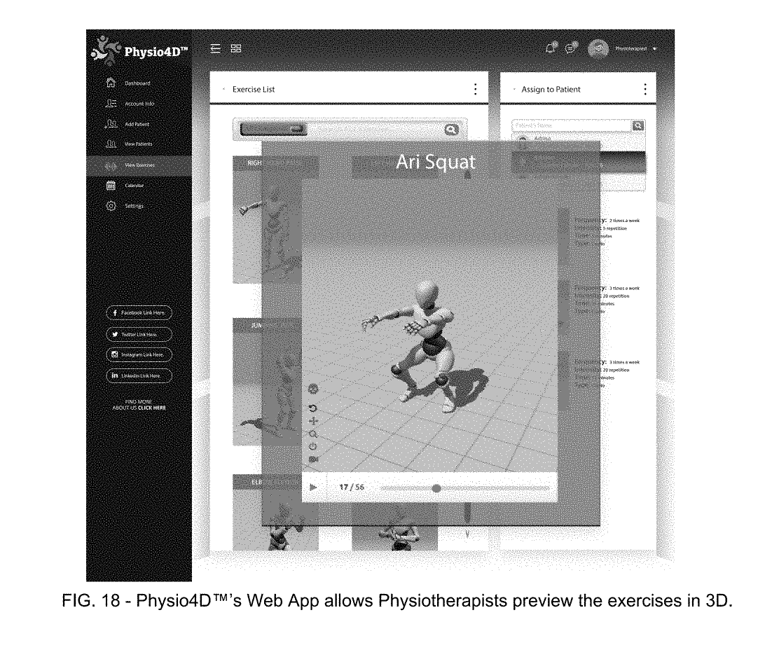

This version also provides physiotherapists access to all of the captured exercises to prescribe the right ones for their patients (see FIG. 16). After the initial meeting, the physiotherapist can search the name of the exercise in the database or filter the exercises based on the painful body part (by clicking on the 3D avatar's corresponding joint). The shortlisted exercises can then be filtered further by the type of the injury or its severity. Finally, physiotherapist can assign the right exercises to the profile of the patient (see FIG. 18). Patients can then download them on their mobile or tablet devices and follow their rehabilitation at home.

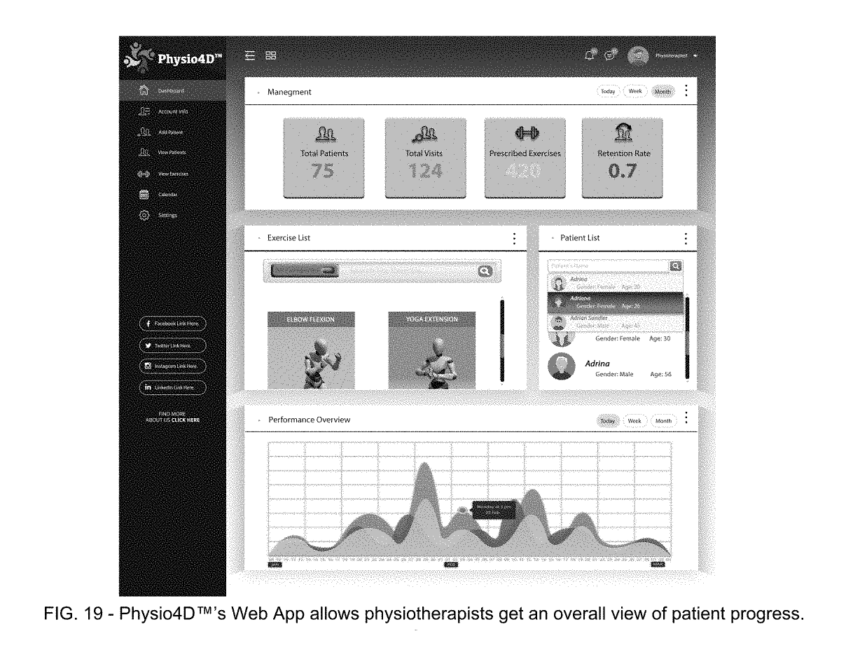

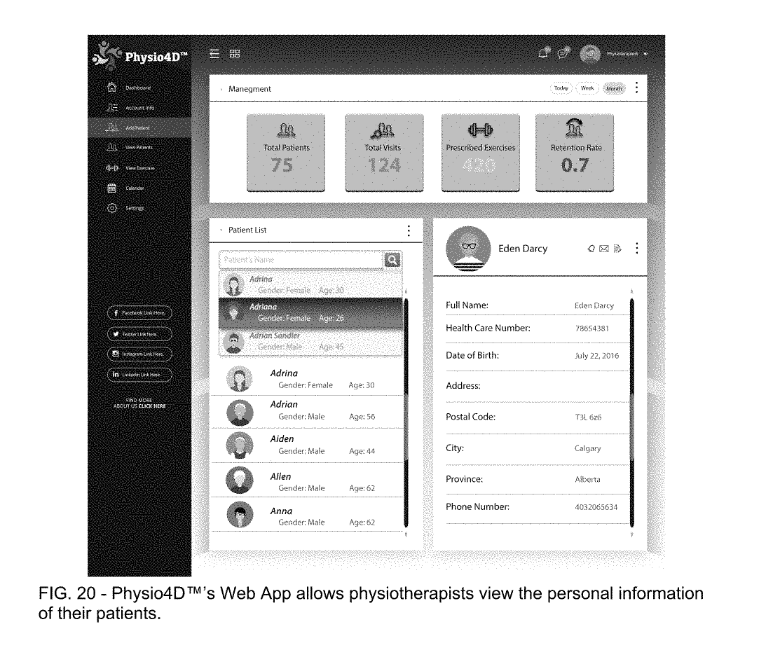

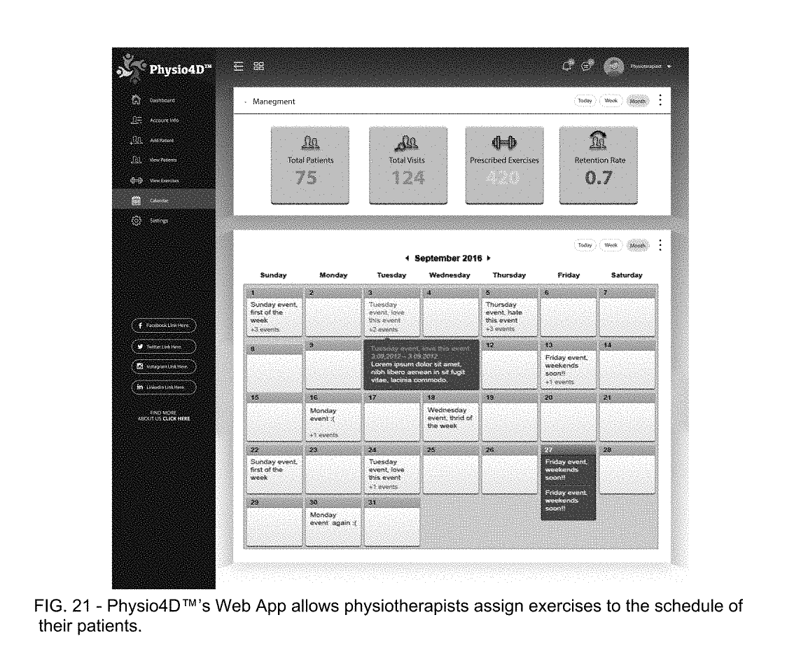

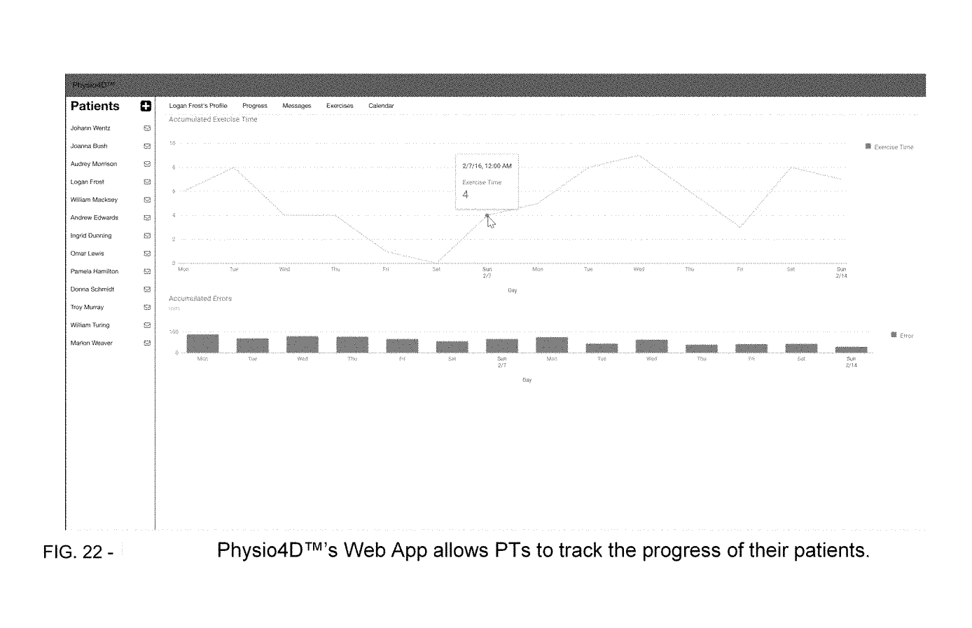

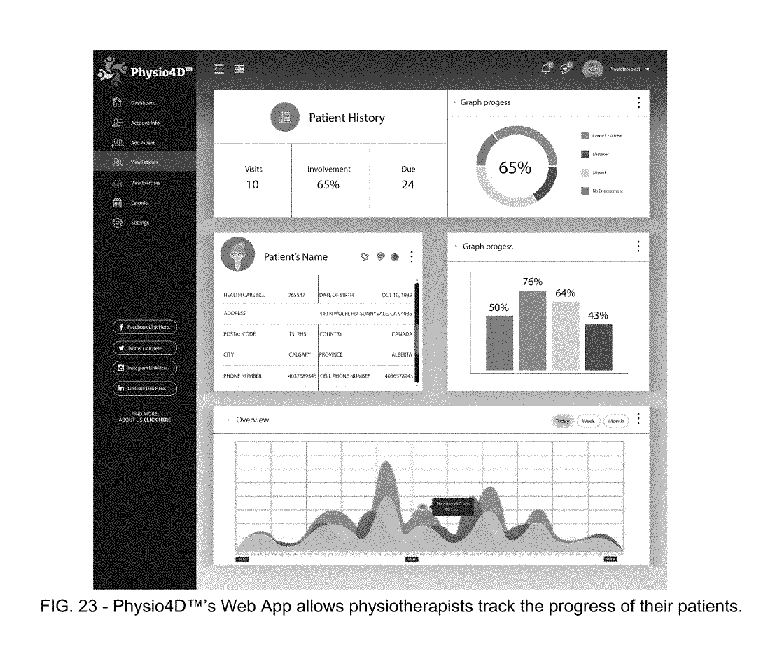

This version shows physiotherapists important analytical information about the progress of their patients over time (see FIG. 22). This allows physiotherapists to easily look up the treatment history of their patients and track their adherence (see FIG. 19). It also uses the logs gathered from the patients across all injury categories as training samples of a machine learning algorithm. After the samples reach to an optimum point, this version can assist in the decision making of the clinicians by providing predictive analytics based on all of these categories. This improves quality of the treatment and results in provision of better patient care.

Recent efforts in commodity computer vision have made the Microsoft Kinect a viable sensing platform for full body tracking, and it has been appropriated for some physiotherapy applications. For example, Huang [1] developed Kinerehab to track arm-based exercise movements. Similarly, Lee et al. [2] used the Kinect to track Tai Chi motions for physical rehabilitation. Similarly, MotionMA [3] uses the Kinect to focus on movement interpretation and feedback for performing repetitions. More recent efforts have explored how to guide movement. A previous work by our academic collaborator, presented in Tang et al. [4] explores how different camera setups and visual guides can be used to help train and support people's efforts in physiotherapy exercises.

The physiotherapist version of Physio4D™ is capable of using Microsoft Kinect's input to show accurate body metrics as well as visual guides to help train and measure patients' activities while doing physiotherapy exercises in clinic. During the time that patients are exercising at clinic, they will see a 3D avatar of each exercise to follow them. These exercises are customized for their injury based on their associated range of motion. Using Microsoft Kinect, we monitor their skeletal movement and compare it with this 3D animation to help them correct heir posture using various visual clues e.g. arrows, angle between joints and color coding of the affected muscles. This allows clinicians to save their time of monitoring patients and provide patient care to more patients.

In the future, the physiotherapist version will provide more advanced functionalities such as exporting a story-board of the exercise by choosing a sequence of the key poses in the motion clip. We also plan to use Augmented Reality headsets for the physiotherapists to assess the patients on their head mounted displays. We also plan to integrate this version to the Electronic Medical Records (EMR) systems of the clinics to help physiotherapists manage their schedule and patient reports. This allows Physio4D™ to create a portal for sharing a patient's treatment history between partnered physiotherapists at different clinics to easily prescribe the exercises based on the patient's history.

To expedite the process of patient onboarding, Physio4D™ offers a comprehensive iOS App that automatizes the upfront assessment of the patients. This App shows different routines followed by clinicians for each body part to input their observations and notes. By offering different forms designed by a clinician, they can quickly complete they full assessment as well as their charting and daily notes while interacting with the patients. It collects the personal information, medical history, conditions, objective and subjective information of the patients and provides a separate section to log daily notes of the physiotherapists. These data will be automatically compiled to a PDF file that is transmitted securely to the clinic's EMR-HER system.

2-2) Patient Version

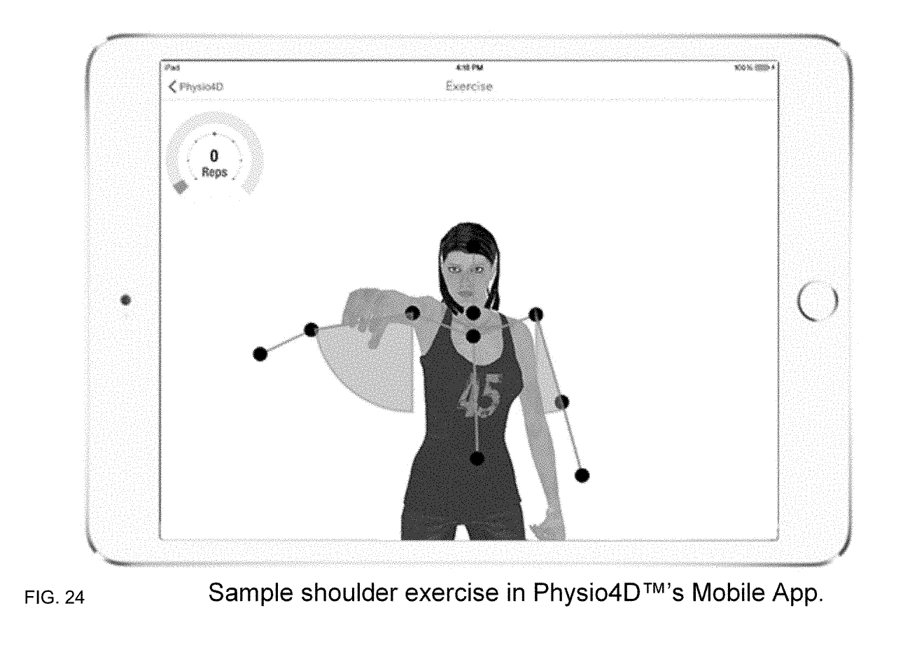

This version provides a Mobile App containing general educational information about physiotherapy exercises. Only after patients visited their physiotherapist for the first time, they can download the prescribed exercises into their mobile devices and follow them up at their home. The Mobile App (see FIG. 24) allows patients to zoom, rotate and view the 3D exercises from multiple angles and with different visualization options (e.g. skin, muscle, and skeleton). Patients can also store their exercise plan in the App's calendar and it will send them push notifications to remind them to do the exercises on time.

The patient App is designed to not only read a motion-captured exercise from the database, but also capture movements of the patient performing the same exercise, and then provide real-time feedback about how well the exercise is being performed (and how to correct the movements). Thus, the patient App needs to have a robust capture system. The trick is to use conventional cameras from mobile phones and tablets, where the feed will be pre-processed to ensure compatibility with lighting, background and camera angle standards, and then normalized based on the height of the person.

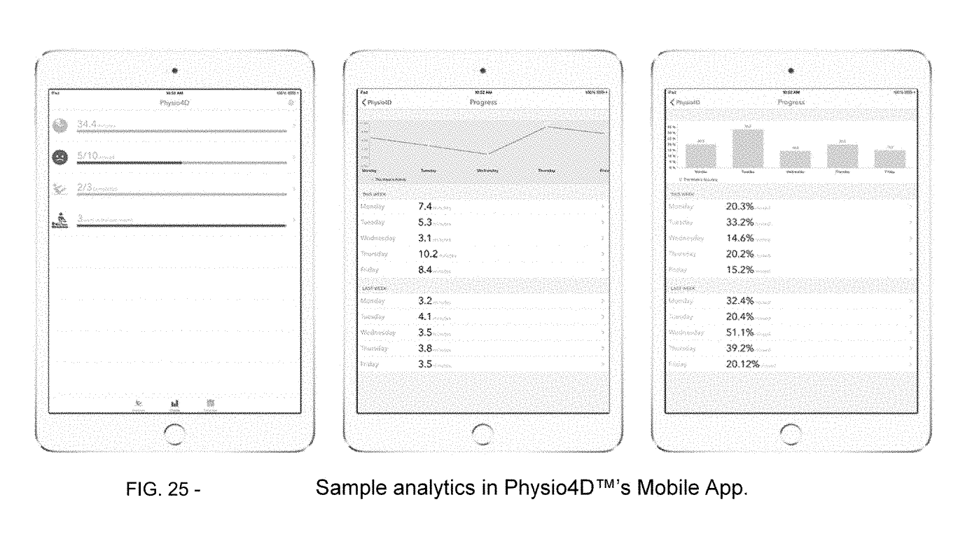

After normalizing the scale, we apply an automatic skeleton extraction algorithm on the camera feed such that we can compare the extracted skeleton with the skeleton of the 3D avatar stored in the mocap database and guide the patient to correct the movement accordingly using various visual clues e.g. arrows and color coding. When patients perform the exercises in front of the camera, their biometric data will be logged to provide analytics about their performance to the physiotherapist (see FIG. 25).

One of the main benefits of Physio4D™ is increasing the compliance of the patients with their exercise program. Physio4D™ allows patients to comment about their experience while performing the exercises. These comments will be available to their physiotherapist to track their progress. The patient comments and the analytical data logged from them while doing the exercises in front of the camera, will fill the current gap between follow-up sessions. The bi-directional communication channel between patients and physiotherapists allows physiotherapists to develop more evidence-based practice for assessment of the success of their treatment, which results in provision of better patient care.

3) Operations

Physio4D™ uses a Try and Buy business model and a SAAS model to generate revenue from its major clients i.e. physiotherapists. It also uses a combination of Freemium and In App Sales business models for the patients. We also envision a secondary revenue stream in future from regulatory bodies, insurance companies, government agencies and researchers through an online subscription model of our biometric database.

3-1) Technology Development

We use an agile methodology to develop and test different modules of our technology. For the intake App, we develop a native iOS App using Swift, but for the patient facing iOS App, we use both Swift and Objective-C. We also use SceneKit because of its support for 3D programming and animation. For the physiotherapists', Desktop App we use Universal Windows Platform and C#. Also, for the Web App, we use HTML5/CSS and new javascript frameworks such as Node.js, Angular.js and Express.js. Our CEO works closely with our developers to manage development of these products on a daily basis. We plan to use IBM Watson Tooling to run data analytics on biometric data gathered from the patients. We also use Google cloud servers to store our database of the 3D motion clips.

To capture the 3D motions, we use Human Performance Lab at the University of Calgary. The exercises are recorded using Cortex tool from Motion Analysis. The raw motions are usually imperfect and need to be cleaned-up from un-wanted artefacts and exported to a skeletal animation using Calcium tool from Motion Analysis. Then our CCO re-targets these motions using Autodesk Motion Builder and Autodesk Maya. The final animation clips are exported to the FBX format which is suitable file format for both iOS and Web.

3-2) Clinical Pilots

We are now piloting our motion tracking solution in a local physiotherapy chain to refine our technology and address the biggest pain points of the clinicians. Based on the positive outcomes of these pilots, we have converted one of the clinics in this chain to our first customer and working on converting the rest. We allow these clinics to try our MVP for free for the period of 14-days. After that, we offer them to continue using Physio4D™ by purchasing a license at a discounted rate for annual orders. The pilot clinics will be our early adaptors to penetrate into the market.

3-3) Technology Licensing

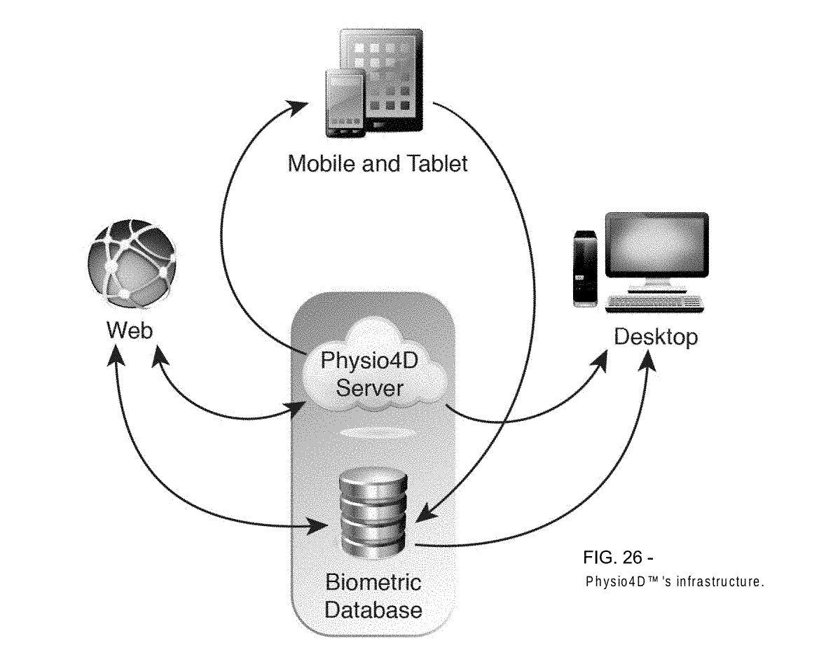

Physio4D™ uses a SAAS model to allow physiotherapists access the Onboarding App, Windows App and Web App with a monthly license. This opens multiple vertical revenue streams for us and minimizes the capital requirement. In addition, it allows us to focus on developing new IP and renew the lifecycle of our product. The basic license for the physiotherapists is $99/month for each product, but the premium licenses that allow them to access more specific types of the exercises would be priced separately. In addition, clients will be charged 25¢/retrieval if they want to access our biometric database for analytical studies. This database will provide insightful analytics to regulatory bodies, government agencies and insurance companies in aggregate form (see FIG. 26).

3-4) In App Sales

The mobile version of Physio4D™ enables patients to access their prescribed 3D exercises for free. However, we will charge them for downloads of the exergames using an In App Sales business model. Exergames is a new trend in video games that combines an element of exercise with traditional gaming. These games are also available in the physiotherapist version of Physio4D™ to be played in clinics.

3-5) Channel Partnership

In order to achieve the best accuracy of the physiotherapy exercises, and increase patient adherence, we plan to integrate Physio4D™ to different wearable sensors in future. New innovations in this area opens partnership opportunities with manufacturers of these sensors. The 3D nature of our platform facilitates adapting Physio4D™ to the haptic devices and sensors that are now used for treatment. For example, using a knee-pad equipped with multiple pressure sensors we can visualize the angle of the knee accurately in 3D and also provide haptic feedback if they exceed the suggested angle during the exercise.

We can work with these partners to provide a hardware/software bundle for the customers. It will be a win-win scenario, because they will benefit from the increased sales through our clients and we can use their channels to distribute our technology. These new versions of our technology will have their own licenses. Our interactive and mobile user experience can provide an efficient way for rehabilitation of musculoskeletal injuries at home, and aid assessment of the patients' progress.

4) References

[1] Huang, J-D. (2011) Kinerehab: a kinect-based system for physical rehabilitation: a pilot study for young adults with motor disabilities. ASSETS, 319-320.

[2] Lee, J-D., Hseih, C-H., & Lin, T-Y. (2014) A Kinect-based Tai Chi exercises evaluation system for physical rehabilitation. ICCE, 177-178.

[3] Velloso, E., et al. (2013) MotionMA: motion modelling and analysis by demonstration. CHI, 1309-1318.

[4] Tang, R., et al. (2015) Physio@Home: Exploring visual guidance and feedback techniques for physiotherapy patients at home. CHI, 4123-4132.

All of the above-cited references are incorporated herein by reference.

In summary of an exemplary embodiment, a physiotherapist consultant performs a core set of exercises in the Human Performance Lab while around 70 reflective markers are attached to his body joints. A set of eight Motion Analysis cameras concurrently capture a regular sampling of his joint parameters over time. After recording the raw data for each exercise, the system extracts the skeletal structure of the character from it. These skeletal animations are later applied to a 3D human model to represent different visualizations. Therefore, some post processing needs to be done on the skeletal avatar to visualize a skinned human, its muscle structure and its nerve system. In addition, the geometric notion of the data allows adding graphical overlays to the visualization such as showing the angles between joints or highlighting the affected muscles.

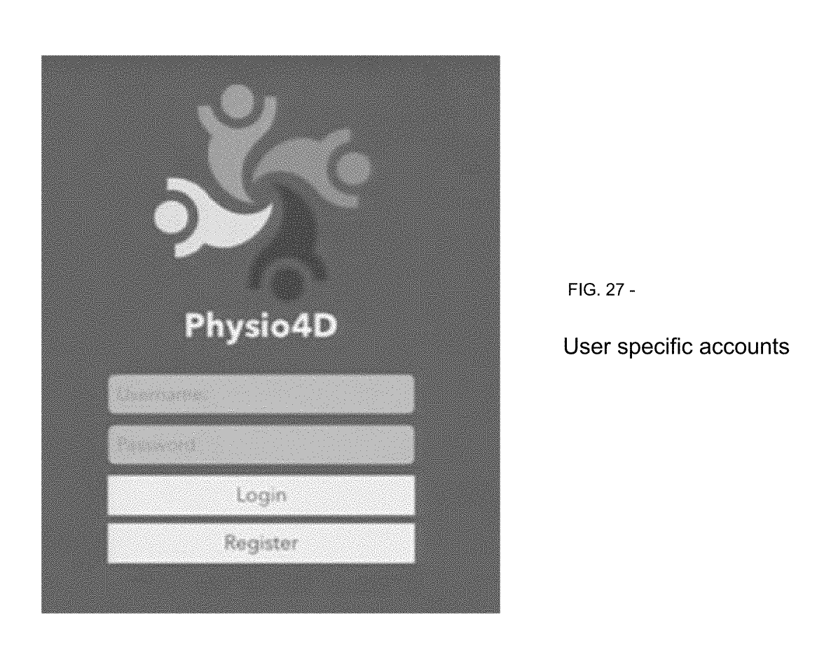

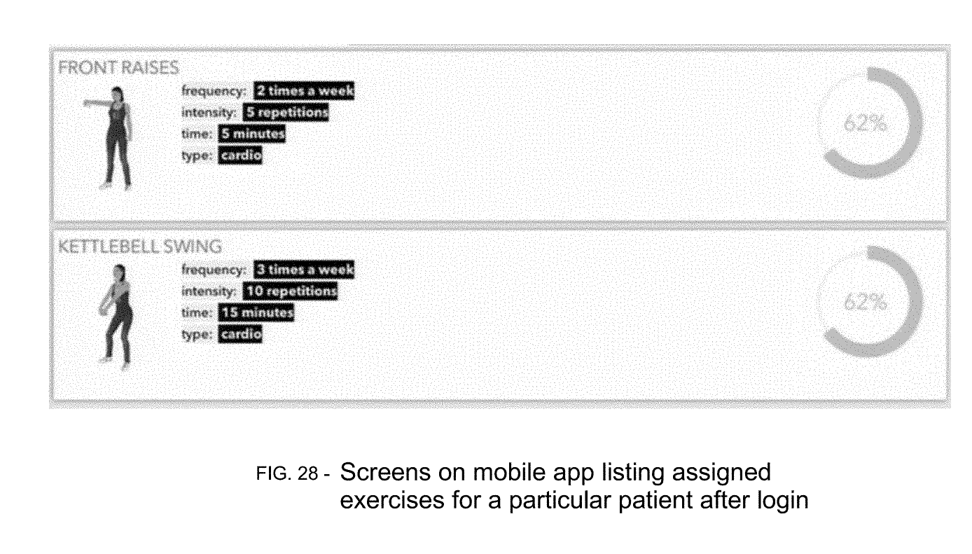

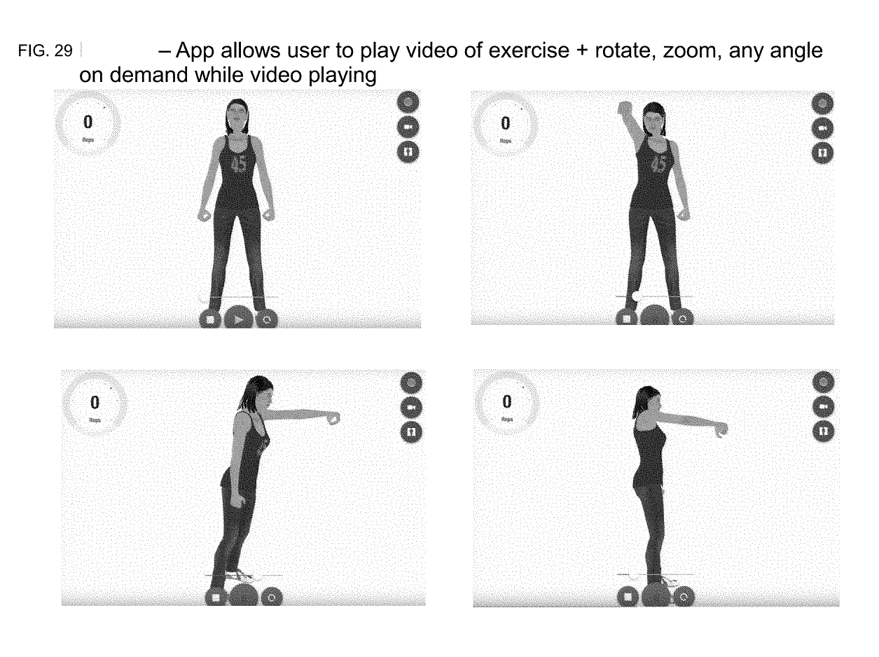

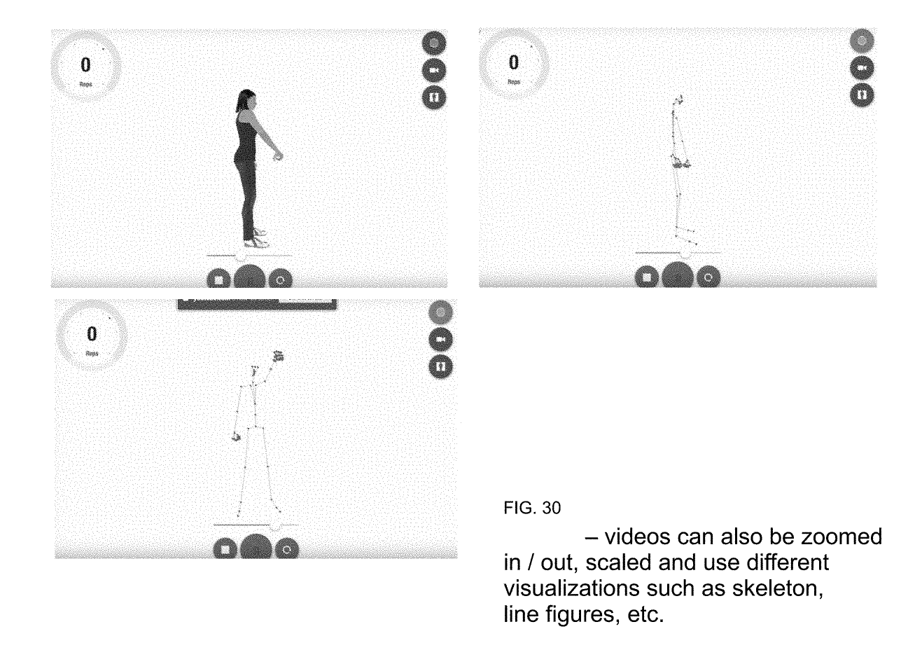

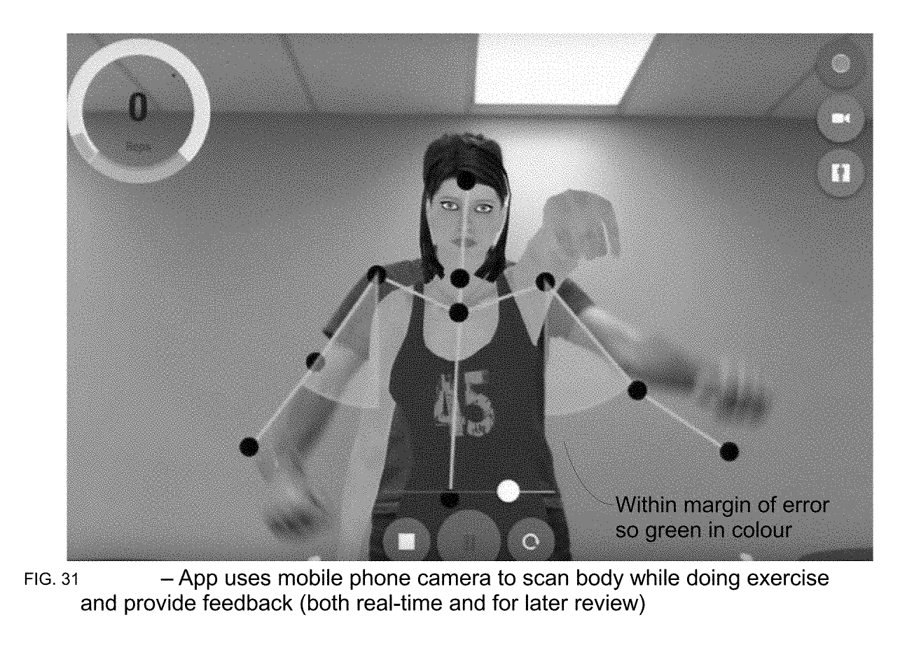

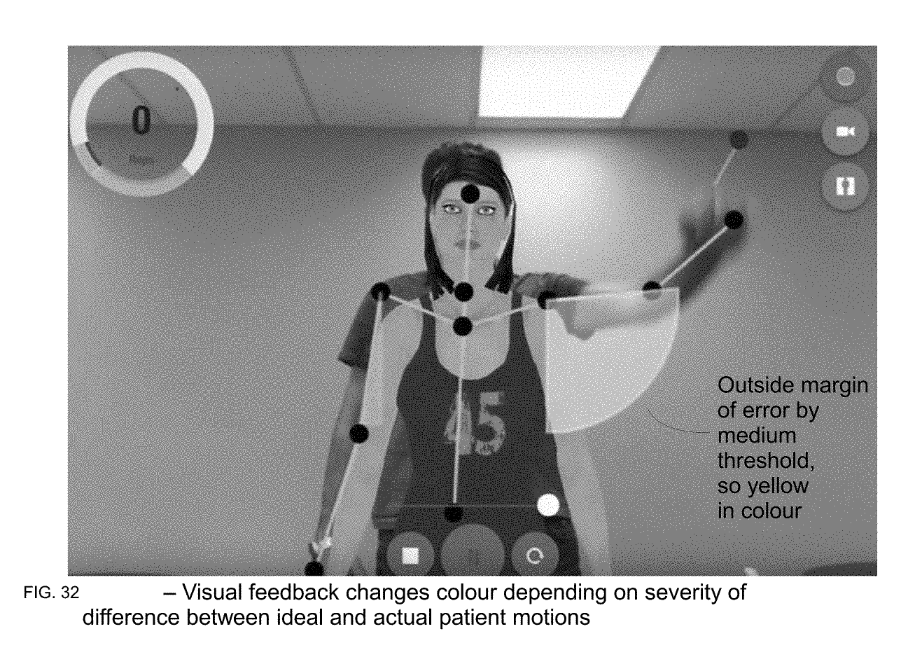

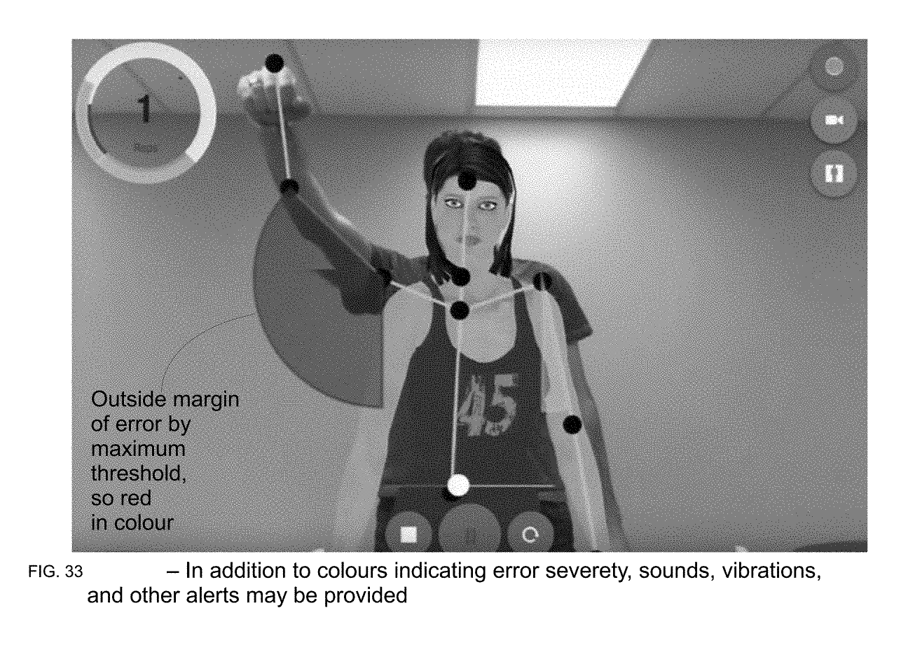

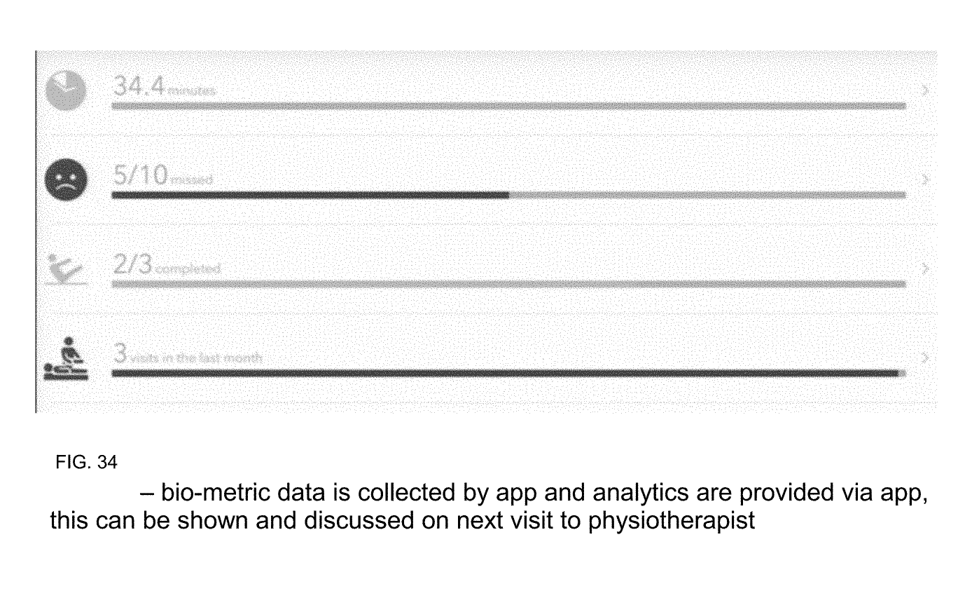

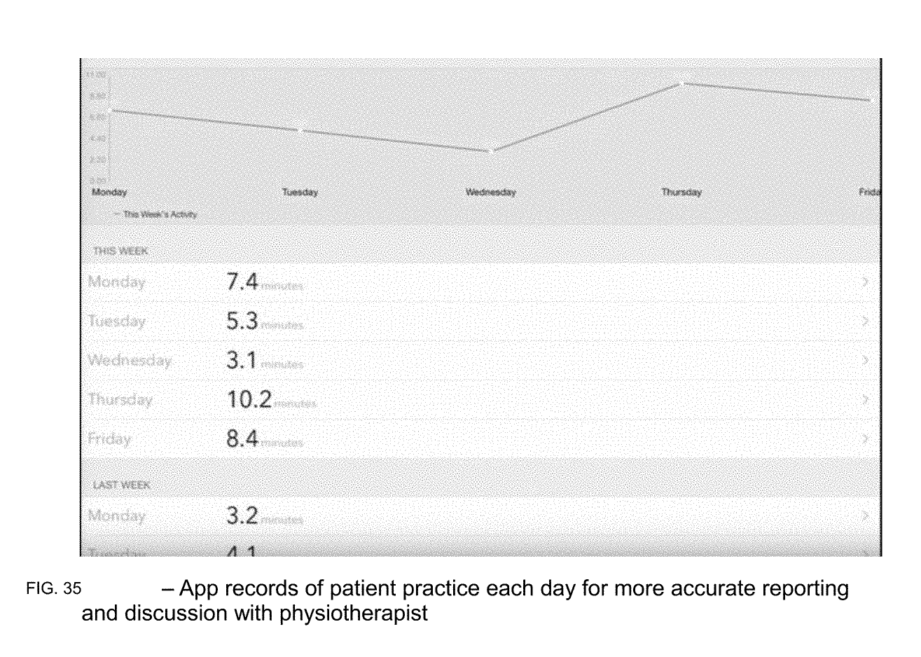

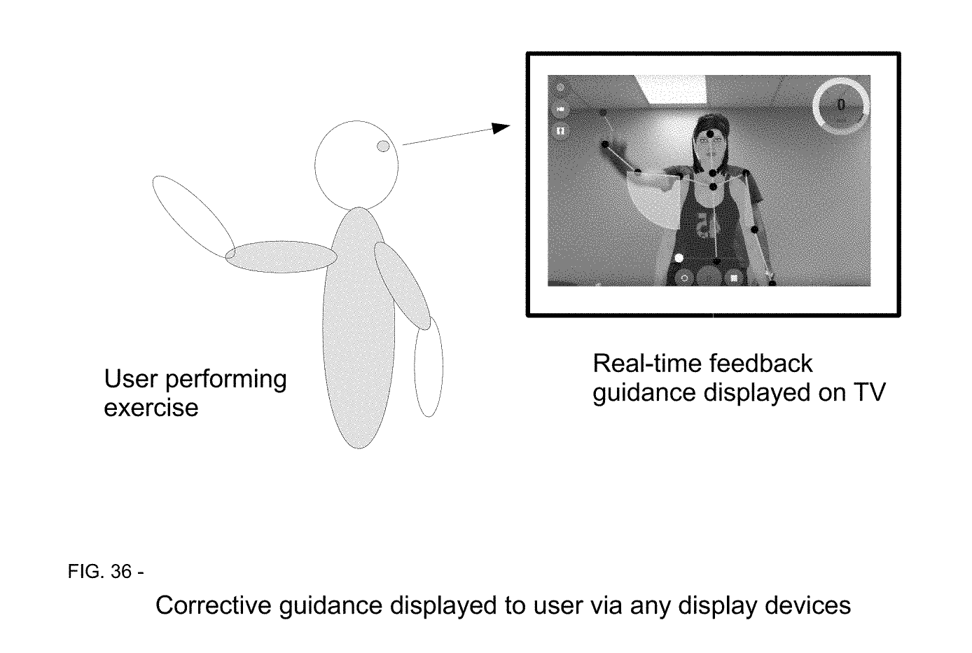

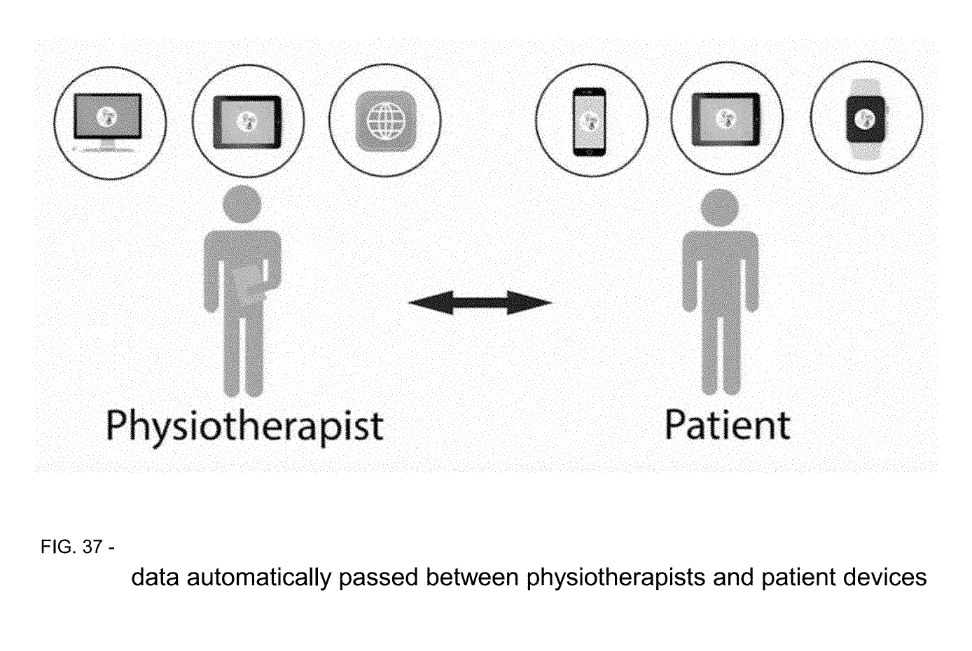

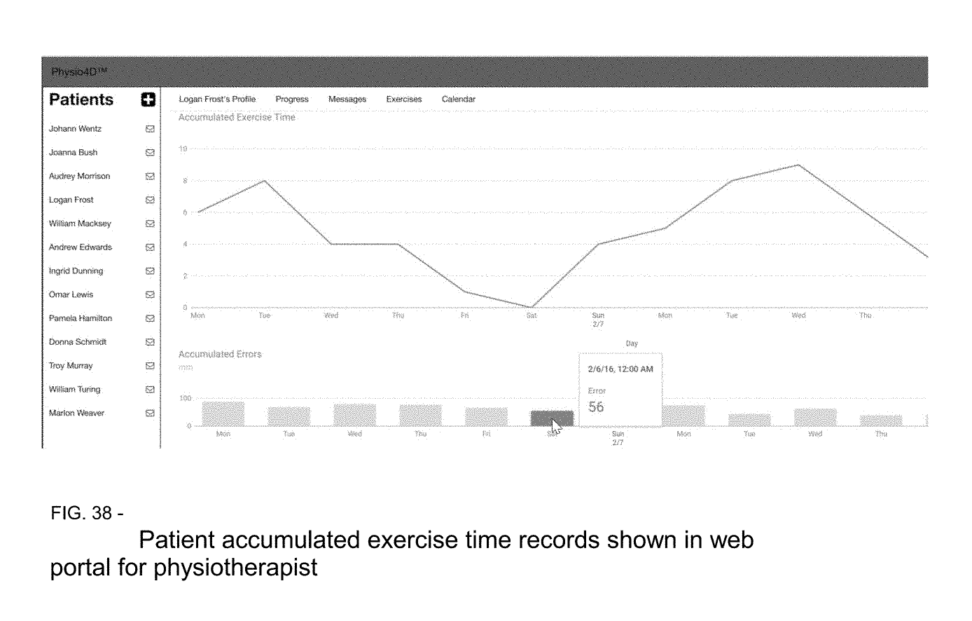

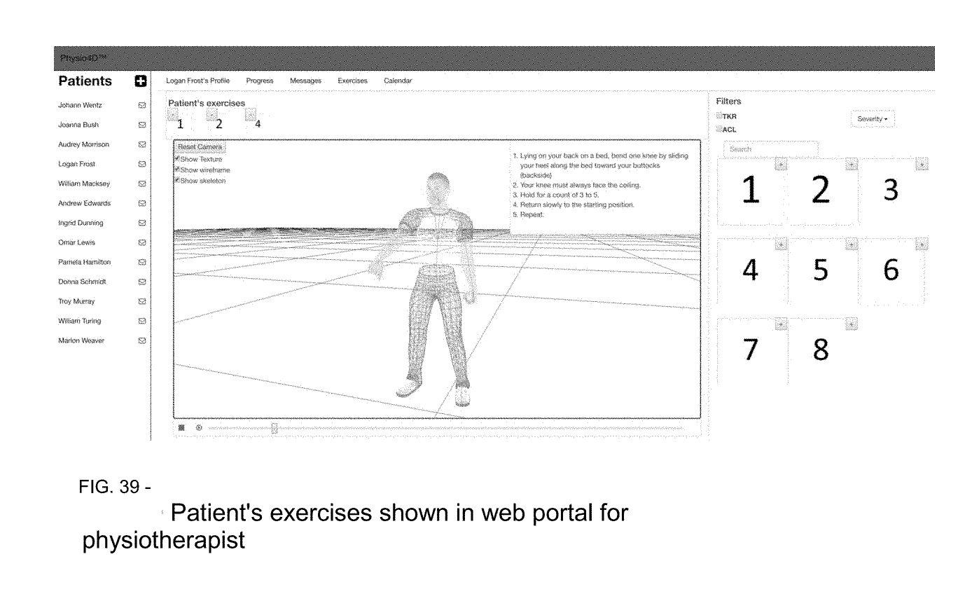

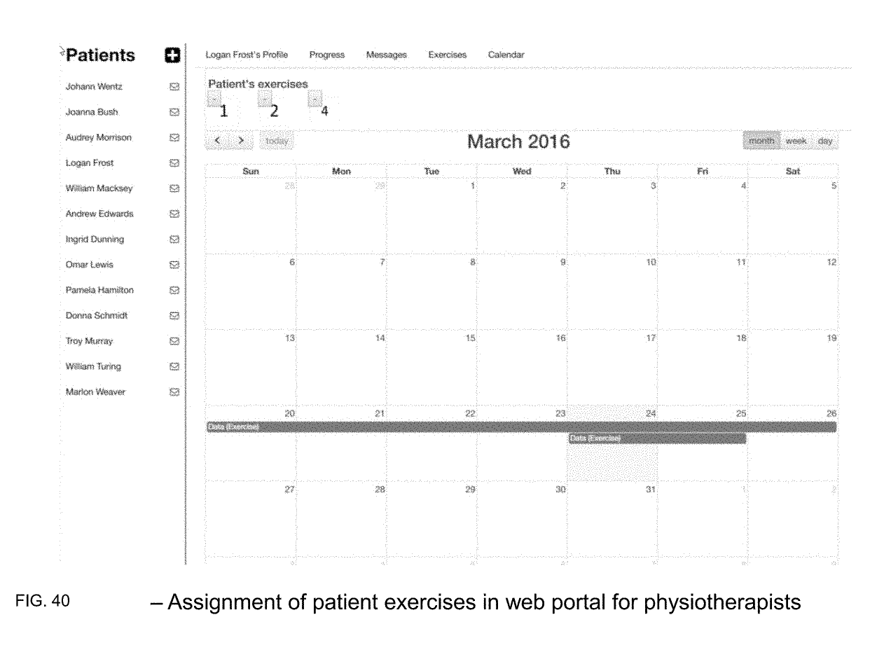

Every 13 seconds an older adult visits an emergency room for a fall related injury. In Physio4D™ we provide a mobile technology for guidance of physical therapy exercises and avoiding some of these injuries. Our App allows patients to download a set of clinically proven motion captured exercises into their mobile devices that are specific for that patient—see patient login in FIG. 27 and list of assigned exercises in FIG. 28. Patients can play 3D animations of the assigned exercises and view, rotate and zoom them from multiple angles—see FIG. 29. And with different visualization options such as skeleton or skin—see FIG. 30. We can also scan the body of the patients in real-time. And provide suggestive feedback using a Computer Vision algorithm—see different coloured feedback indicators in FIGS. 31, 32, and 33. This helps patients to correct their movements and may be displayed to the user in real-time on a television or other display device in front of the user—see FIG. 36. We also measure their analytical information during the exercise. And provide progress reports using different charts and diagrams—examples of analytics and reports provided in FIG. 34 and FIG. 35. These analytics will be provided to the physiotherapists during their follow-up meetings or automatically via a computer network such as the Internet—see FIG. 37. To provide an evidence-based assessment of the success of their treatment.

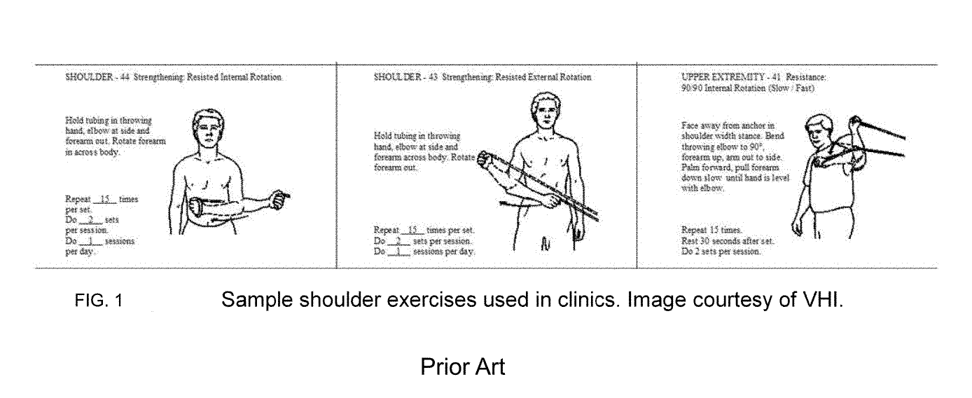

In an exemplary embodiment, a mobile, interactive and accurate patient care system is disclosed to increase the compliance of patients with their rehabilitation. In early 2015, one of the co-inventors had a shoulder injury and when visited a physiotherapist, he provided some stick figure sketches like those shown in FIG. 1, and emphasized that most of the rehabilitation depends on following these exercises correctly at home. But it was easy to forget to do these simple routines and even when remembered, it was not possible to know if they were being done correctly or not while at home. Feeling the continued pain provided motivation to find a way to increase adherence to the program. This lack of compliance is more important considering the fact that the world's population is aging.

By 2036 we will have more than 10 million seniors in Canada and by 2051 one out of 4 Canadians will be aged 65 or over. This population has the greatest exposure to the musculoskeletal injuries caused by incidents such as falling.

The tools that are currently used in physiotherapy clinics for automation of exercise instruction and tracking tend to be based either on still images that are insufficiently accurate or based on video exercises that do not provide critical 3D visual clues.

Solution

Physio4D™'s starts automatization from the moment patient walks into the clinic through a digital onboarding process that helps clinicians complete their charting and daily notes while interacting with the patients. Physio4D™'s onboarding App is unique in its kind because it saves a lot of time spent by clinicians on charting and daily notes. This app is designed by clinicians for clinicians using the best practice guidelines in the field of physical therapy. It collects the personal information, medical history, conditions, objective and subjective information of the patients. It also has a separate section to log daily notes of the physiotherapists. All of these data are automatically compiled into a detailed PDF to save the charting and documentation tracking time. The advantage of this app is that it enables clinicians to use dictation and talk instead of type. This allows them to be more around their patients not their computers.

As part of the objective examination section of the onboarding process, we developed a Windows App to track the range of motion (ROM) of the patients and provide reliable assessments of the patient progression. Physiotherapists like the idea of having a tool that provides a hands-free assessment of the joint mobility. Physio4D™ allows clinicians to select a joint and choose from the standard assessments for that joint. We couple a depth camera to our machine vision algorithm to automatically detect the skeletal data and track the joint angles. This provides an objective, hands-off measurement of the joint mobility and allows ROM to be measured passively.

Physio4D™'s Windows App reduces variability between visits and provides a more reliable measure of patient progression. It also allows clinicians to see the ROM progress of their patients using different charts. In addition, using a repository of exercises that are customized by experienced clinicians, Physio4D™ prescribes custom treatment plans. By employing an intelligent exercise recommendation algorithm, Physio4D™ increases efficiency of the treatment and enables physical therapists to automatically prescribe these custom exercises to their patients. They can also generate a PDF report outlining the progress charts as well as the before/after images of the patients. Merging assessment, reporting and automatic charting expedites the triage process, allowing clinicians to see more patients per day.

We also offer patients a set of 3D motion captured exercises which have shown the most accuracy of exercise instruction, and allow them to see the exercises from multiple angles and with different visualization options such as skin, muscle and skeleton. In addition, we utilize the cameras of common handheld devices to automatically scan the body of the patients in real-time and provide on-screen, corrective guidance. Physio4D™ provides a mobile communication platform between patients and physiotherapists that results in better patient care. We believe that Physio4D™ can reduce the risk of these injuries by guiding the patients to self-manage their rehabilitation.

A software application runs at the physiotherapist computer and also on the user's mobile device such as a smart phone. In an example embodiment, on the patient's mobile phone there is displayed: an updated login page, an assigned exercise list (the ones that recommended to the patient), an optional exercise list, the chart's dashboard showing summary data, the time spent on the various exercises, the errors made, the reps completed, a calendar view showing dates that exercises are assigned, nearby clinics on a map around the current location of the user, contact details of a particular clinic, the specific notes regarding particular exercises, and various messages sent back and forth between patient and physiotherapist.

Although the invention has been described in connection with preferred embodiments, it should be understood that various modifications, additions and alterations may be made to the invention by one skilled in the art without departing from the spirit and scope of the invention.

Modules may be implemented by software executed by one or more processors operating pursuant to instructions stored on a tangible computer-readable medium such as a storage device to perform the above-described functions of any or all aspects of the system. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the system or any of the above-described portions thereof as a result of executing the instructions.

In other embodiments, rather than being software modules executed by one or more processors, the modules may be implemented as hardware modules configured to perform the above-described functions. Examples of hardware modules include combinations of logic gates, integrated circuits, field programmable gate arrays, and application specific integrated circuits, and other analog and digital circuit designs.

Functions of single modules may be separated into multiple units, or the functions of multiple modules may be combined into a single unit. Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. An apparatus as shown and described herein.

2. A system as shown and described herein.

3. A method as shown and described herein.
